(19) United States
(12) Patent Application Publication
(10) Pub. No.: US 2017/0194747 A1
(43) Pub. Date: Jul. 6, 2017

(54) UNIVERSAL SERIAL BUS (USB) ON-THE-GO (OTG) DEVICE

(71) Applicant: SAMSUNG ELECTRONICS CO., LTD., Suwon-si (KR)

(72) Inventors: Eunseok HONG, Suwon-si (KR); Cheolho LEE, Suwon-si (KR); Joongho KIM, Seongnam-si (KR); Hwanwoo SHIM, Hwaseong-si (KR)

(21) Appl. No.: 15/341,294

(22) Filed: Nov. 2, 2016

(30) Foreign Application Priority Data
Jan. 4, 2016 (KR) 10-2016-0000335

(51) Int. Cl. H01R 13/6581; H01R 31/06; H01R 27/02; H01R 24/62; H01R 24/60

(52) U.S. Cl. CPC H01R 13/6581; H01R 24/62; H01R 24/60; H01R 27/02; H01R 31/06; H01R 2107/00

(57) ABSTRACT

In various example embodiments, a universal serial bus (USB) on-the-go (OTG) device includes at least four pins for transmitting or receiving an electric signal, a plug connector electrically connected with a USB receptacle connector of a first electronic device through first ends of the at least four pins, and a receptacle connector electrically connected with a USB plug connector of a second electronic device through second ends of the at least four pins. In this USB OTG device, at least portions of the first ends of the at least four pins are mounted in the plug connector, and at least portions of the second ends of the at least four pins are mounted in the receptacle connector. Other embodiments are also possible.

### CROSS-REFERENCE TO RELATED APPLICATION

This application is based on and claims priority under 35 U.S.C. §119 to a Korean patent application filed on Jan. 4, 2016 in the Korean Intellectual Property Office and assigned Serial number 10-2016-0000335, the disclosure of which is incorporated by reference herein in its entirety.

### TECHNICAL FIELD

The disclosure relates generally to a universal serial bus (USB) on-the-go (OTG) device connected between electronic devices to deliver an electric signal between the electronic devices.

### BACKGROUND

USB, short for a universal serial bus, is an industry standard developed by Intel, Microsoft, Compaq, NEC, etc. so as to easily connect peripheral devices to a personal computer and to meet a multimedia environment.

A USB device may have a form of plug connector or receptacle connector, which corresponds to each other. The plug connector has a structure being insertable into the device connector by having a protruding part to be inserted into an insertion hole of the receptacle connector. The receptacle connector has a vertically reversed structure in comparison with the plug connector and thus can be inserted into the plug connector. The plug connector and the receptacle connector may have, at their protruding part, terminals confronting each other and to be in contact with each other. Electric power and data may be delivered through such terminals. In the USB 2.0 standard, terminals are basically formed of four types, i.e., GND, D(+), D(−), and Vcc. Additionally, a certain external devices, such as a mouse, a keyboard, a USB memory, or the like, may be recognized through a USB OTG device including USB micro five pins used in a mobile device.

Unfortunately, the USB OTG device that transmits and receives an electric signal through a printed circuit board (PCB) and cable has several drawbacks, due to use of the PCB and cable, such as an increase in manufacturing cost, a decrease in production rate, a radio frequency (RF) noise caused by soldering between the PCB and cable, and an incomplete prevention of degradation in RF performance.

### SUMMARY

Various example embodiments of the present disclosure provide a universal serial bus (USB) on-the-go (OTG) device in which at least four pins are arranged, at one ends thereof, in at least parts of a plug connector and also arranged, at the other ends thereof, in at least parts of a receptacle connector.

The USB OTG device according to various example embodiments may include at least four pins for transmitting or receiving an electric signal; a plug connector electrically connected with a USB receptacle connector of a first electronic device through first ends of the at least four pins; and a receptacle connector electrically connected with a USB plug connector of a second electronic device through second ends of the at least four pins. In this USB OTG device, at least portions of the first ends of the at least four pins may be mounted in the plug connector, and at least portions of the second ends of the at least four pins may be mounted in the receptacle connector.

The USB OTG device according to various example embodiments may prevent and/or reduce the occurrence of RF noise and the degradation of RF performance by transmitting and receiving an electric signal through pins integrated between the plug connector and the receptacle connector, rather than using the PCB and cable.

The USB OTG device according to various example embodiments may also prevent and/or reduce the occurrence of RF noise and the degradation of RF performance using a shieldcan integrated with the plug connector and the receptacle connector.

The various example embodiments do not require soldering, thus reducing manufacturing cost and promoting a higher production rate.

### BRIEF DESCRIPTION OF THE DRAWINGS

The above and other aspects of the disclosure will be more apparent from the following detailed description, taken in conjunction with the accompanying drawings, in which like reference numerals refer to like elements, and wherein:

FIG. 1 is a block diagram illustrating an example USB OTG device according to various example embodiments.

FIGS. 2A and 2B are perspective views illustrating an example receptacle connector of a USB OTG device according to various example embodiments.

FIG. 3 is a perspective view diagram illustrating an example USB OTG device 101 including a shieldcan 300 according to various example embodiments.

FIG. 4 is a perspective view illustrating an example USB OTG device in which a receptacle connector, a plug connector and a shieldcan are combined, according to various example embodiments.

FIG. 5 is a perspective view diagram illustrating an example USB OTG device 101 including a case 500 according to various example embodiments.

FIG. 6A is a cross-sectional view illustrating an example plug connector of USB 2.0 standard or USB 3.0 standard according to various example embodiments.

FIG. 6B is a cross-sectional view illustrating an example plug connector of USB 3.0 standard or USB 3.1 standard according to various example embodiments.

### DETAILED DESCRIPTION

The following description is made with reference to the accompanying drawings is provided to assist in a comprehensive understanding of various example embodiments of the present disclosure as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

As used herein, the singular forms “a”, “an”, and “the” are intended to include the plural forms, including “at least one”, unless the content clearly indicates otherwise. “Or” means “and/or”. As used herein, the term “and/or” includes any and all combinations of one or more of the associated listed items. It will be further understood that the terms “comprises” and/or “comprising”, or “includes” and/or “including” when used in this description, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first”, “second”, “third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element”, “component”, “region”, “layer” or “section” discussed below could be termed a second element, component, region, layer or section without departing from the teachings herein.

In this disclosure, an electronic device may be a device that involves a communication function. For example, an electronic device may be a smart phone, a tablet PC (Personal Computer), a mobile phone, a video phone, an e-book reader, a desktop PC, a laptop PC, a netbook computer, a PDA (Personal Digital Assistant), a PMP (Portable Multimedia Player), an MP3 player, a portable medical device, a digital camera, or a wearable device (e.g., an HMD (Head-Mounted Device) such as electronic glasses, electronic clothes, an electronic bracelet, an electronic necklace, an electronic appcessory, or a smart watch), or the like, but is not limited thereto.

According to some embodiments, an electronic device may be a smart home appliance that involves a communication function. For example, an electronic device may be a TV, a DVD (Digital Video Disk) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame, or the like, but is not limited thereto.

According to some embodiments, an electronic device may be a medical device (e.g., MRA (Magnetic Resonance Angiography), MRI (Magnetic Resonance Imaging), CT (Computed Tomography), ultrasonography, etc.), a navigation device, a GPS (Global Positioning System) receiver, an EDR (Event Data Recorder), an FDR (Flight Data Recorder), a car infotainment device, electronic equipment for ship (e.g., a marine navigation system, a gyrocompass, etc.), avionics, security equipment, or an industrial or home robot, or the like, but is not limited thereto.

According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof. As well understood by those skilled in the art, the above-mentioned electronic devices are example only and not to be considered as a limitation of this disclosure.

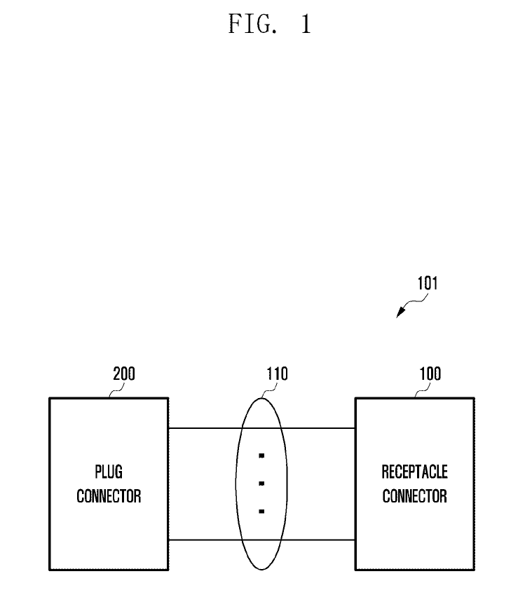

FIG. 1 is a block diagram illustrating an example USB OTG device 101 according to various example embodiments.

In various example embodiments, the USB OTG device 101 may include a receptacle connector 100, a plug connector 200, and at least four pins 110. The USB OTG device 101 may be electrically connected with the first electronic device through the plug connector 200 and with the second connector through the receptacle connector 100. The USB OTG device 101 may perform a function to deliver an electric signal transmitted or received between the first and second electronic devices.

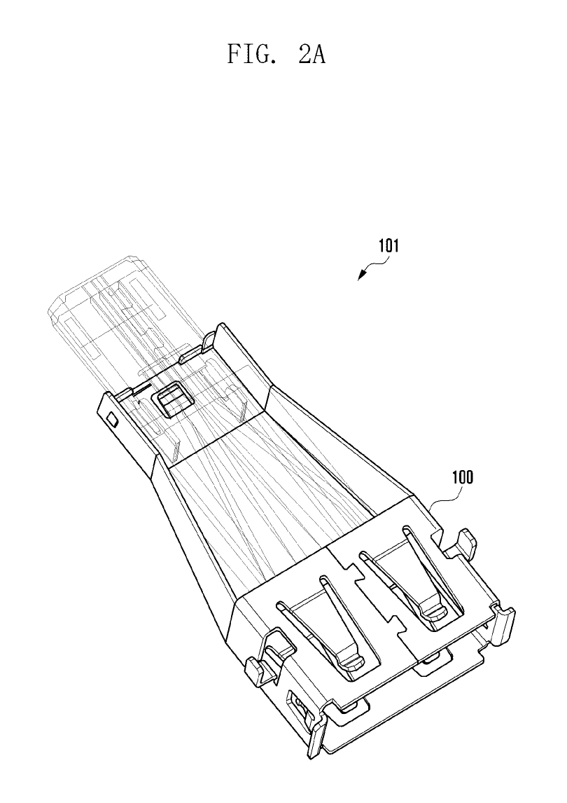

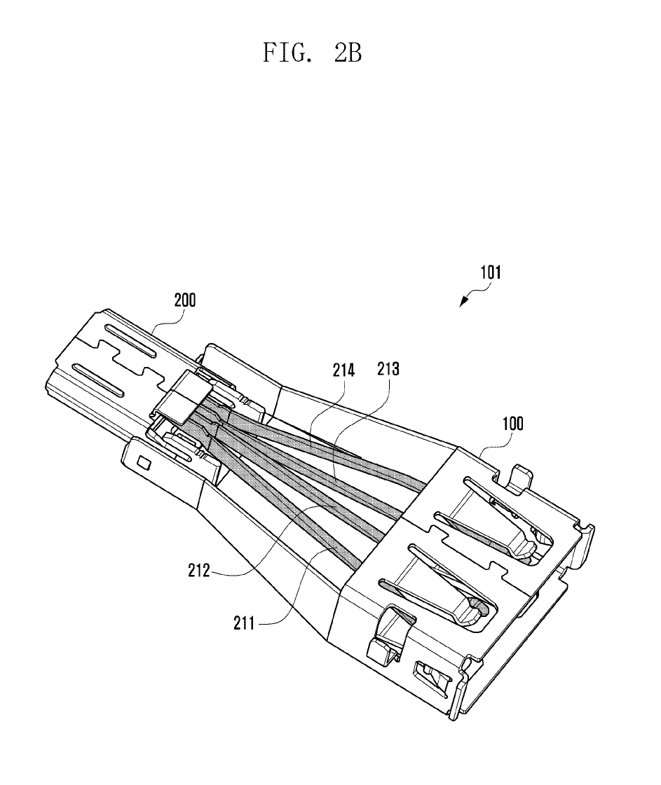

In various example embodiments, the receptacle connector 100 may be connected with the plug connector 200 such that a connecting part of the receptacle connector 100 and a connecting part of the plug connector 200 may face each other. Also, the receptacle connector 100 may be electrically connected with the second electronic device through one ends of the at least four pins 110. For example, referring to FIG. 2A, one end of each of the at least four pins 110 may be arranged in at least parts of the receptacle connector 100 so as to be electrically connected with the second electronic device. The receptacle connector 100 may have, for example, a rectangular shape suitable for insertion of a plug connector of the second electronic device. The receptacle connector 100 may have a mold body suitable for connection and fixation of the plug connector of the second electronic device to be in contact with the at least four pins 110. In order to prevent and/or avoid the plug connector of the second electronic device inserted in the receptacle connector 100 from being released, some locking protrusions may be formed on the periphery of the receptacle connector 100.

In various example embodiments, the plug connector 200 may be electrically connected with the first electronic device through the other (e.g., opposite) ends of the at least four pins 110. For example, referring to FIG. 2B, the other ends of the at least four pins 110 may be arranged in at least parts of the plug connector 200 so as to be electrically connected with the first electronic device. The plug connector 200 may, for example, have a Mini-AB plug or Micro-AB plug shape of the USB 2.0 standard so as to be inserted into a receptacle connector of the first electronic device, e.g., a mobile device. The plug connector 200 may have a mold body suitable for connection and fixation of the receptacle connector of the first electronic device to be joined with the at least four pins 110. In order to prevent the plug connector 200 inserted into the receptacle connector of the first electronic device from being released, at least one locking hole may be formed through one side of the plug connector 200.

In various example embodiments, the at least four pins 110 may deliver an electric signal from the first electronic device to the second electronic device, and vice versa. For example, referring to FIG. 2B, the one ends of the at least four pins 110 may be arranged in at least parts of the plug connector 200, and the other ends of the at least four pins 110 may be arranged in at least parts of the receptacle connector 100. For example, the at least four pins 110 may comply with the USB 2.0 standard. For example, referring to FIG. 2B, the at least four pins of the USB OTG device 101 may include a first pin 211 for delivering a power signal (VBUS), a second pin 212 for delivering a first differential data signal (Data+), a third pin 213 for delivering a second differential data signal (Data−), and a fourth pin 214 for delivering a ground signal (GND). The at least four pins 110 may further include a fifth pin (not shown) for delivering a device recognition signal of the first or second electronic device, in addition to the first pin 211 to the fourth pin 214. The fifth pin may be electrically connected with the fourth pin for delivery of a ground signal.

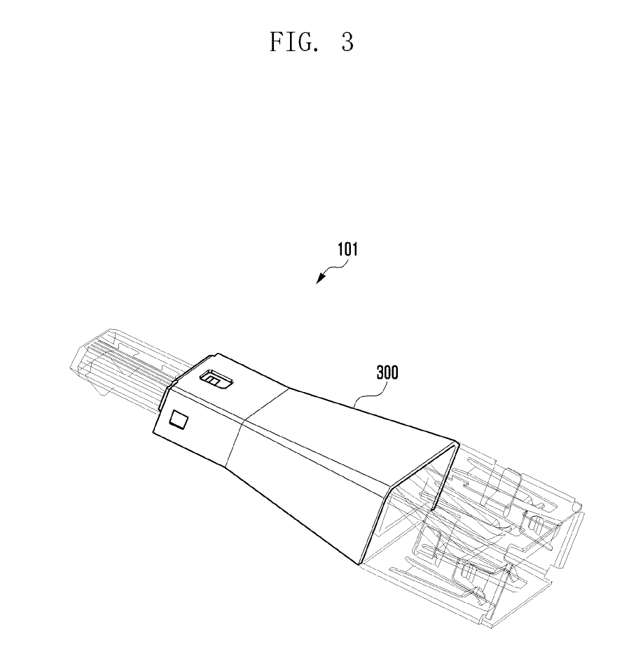

FIG. 3 is a perspective view diagram illustrating an example USB OTG device 101 including a shieldcan 300 according to various example embodiments.

Referring to FIG. 3, the USB OTG device 101 in various example embodiments may further include the shieldcan 300 for blocking the emission of electromagnetic waves. The shieldcan 300 may be configured to encompass at least parts of the receptacle connector 100 and at least parts of the plug connector 200. The USB OTG 101 may effectively prevent and/or reduce the occurrence of a radio frequency (RF) noise through the shieldcan 300 integrated with both the receptacle connector 100 and the plug connector 200. The shieldcan 300 of the USB OTG device 101 may have various shapes suitable for an effective prevention of the RF noise, not limited to the above example.

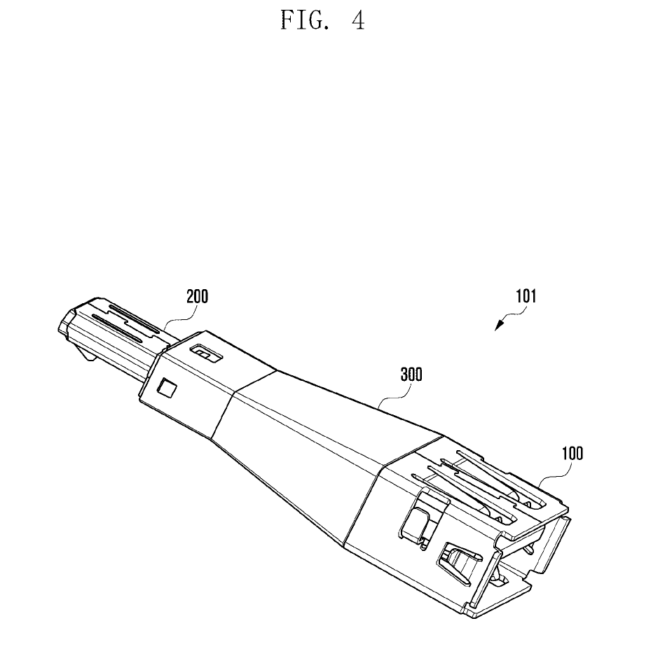

FIG. 4 is a perspective view illustrating the USB OTG device 101 in which the receptacle connector 100, the plug connector 200 and the shieldcan 300 are combined, according to various example embodiments.

Referring to FIGS. 2 and 4, the receptacle connector 100 of the USB OTG device 101 in various example embodiments may have a type-A receptacle shape of the USB 2.0 standard, and the plug connector 200 of the USB OTG device 101 may have a Micro-A plug or Micro-B plug shape of the USB 2.0 standard. The receptacle connector 100 having the type-A receptacle shape of the USB 2.0 standard may have at least parts of four pins including a pin for delivering the power signal, a pin for delivering the first deferential data signal, a pin for delivering the second differential data signal, and a pin for delivering the ground signal. The plug connector 200 having the Micro-A plug or Micro-B plug shape of the USB 2.0 standard may have at least parts of five pins including a pin for delivering the power signal, a pin for delivering the first differential data signal, a pin for delivering the second differential data signal, a pin for delivering the ground signal, and a pin for delivering the device recognition signal. In this case, the pin for delivering the power signal, the pin for delivering the first differential data signal, the pin for delivering the second differential data signal, and the pin for delivering the ground signal may be arranged, at one ends thereof, in at least parts of the plug connector 200 and also arranged, at the other ends thereof, in at least parts of the receptacle connector 100. The pin for delivering the device detection signal of the plug connector 200 may be arranged, at one end thereof, in at least parts of the plug connector 200 and also electrically connected, at the other end thereof, with one of the other four pins of the plug connector 200.

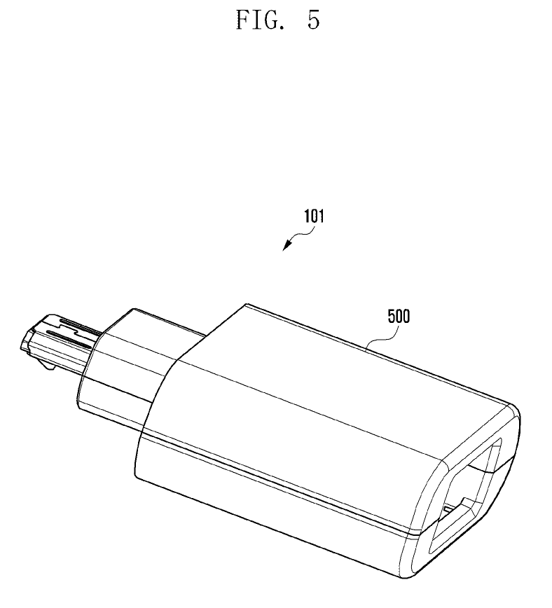

FIG. 5 is a perspective view diagram illustrating an example USB OTG device 101 including a case 500 according to various example embodiments.

Referring to FIG. 5, the USB OTG device 101 in various example embodiments may further include the case 500 for protecting the exterior of the shieldcan 300, the plug connector 200, and the receptacle connector 100. The case 500 may, for example, have one shape selected from a tetrahedron, a pentahedron, a hexahedron, a heptahedron, and an octahedron, or the like. The case 500 of the USB OTG device 101 may have various shapes suitable for protecting the exterior of the shieldcan 300, the plug connector 200, and the receptacle connector 100, not limited to the above example.

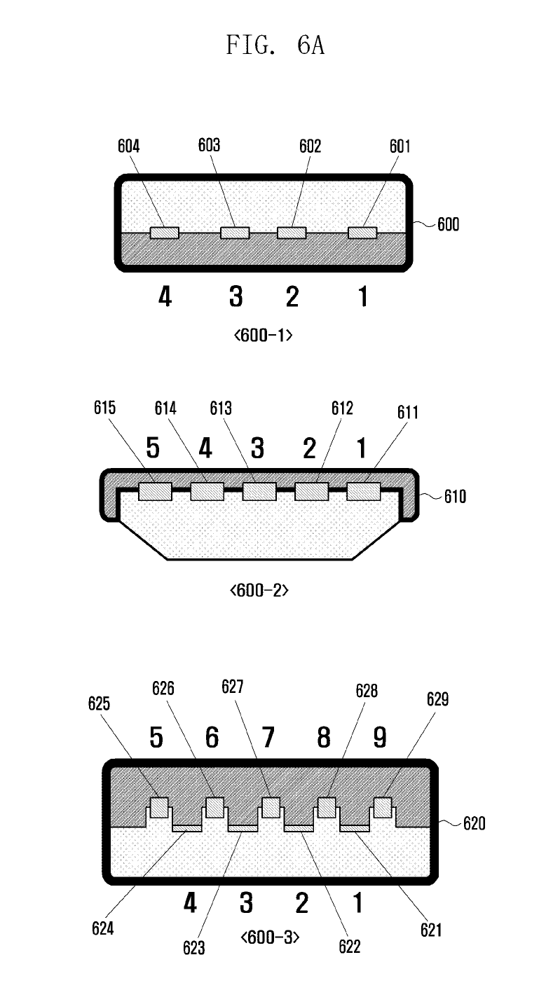

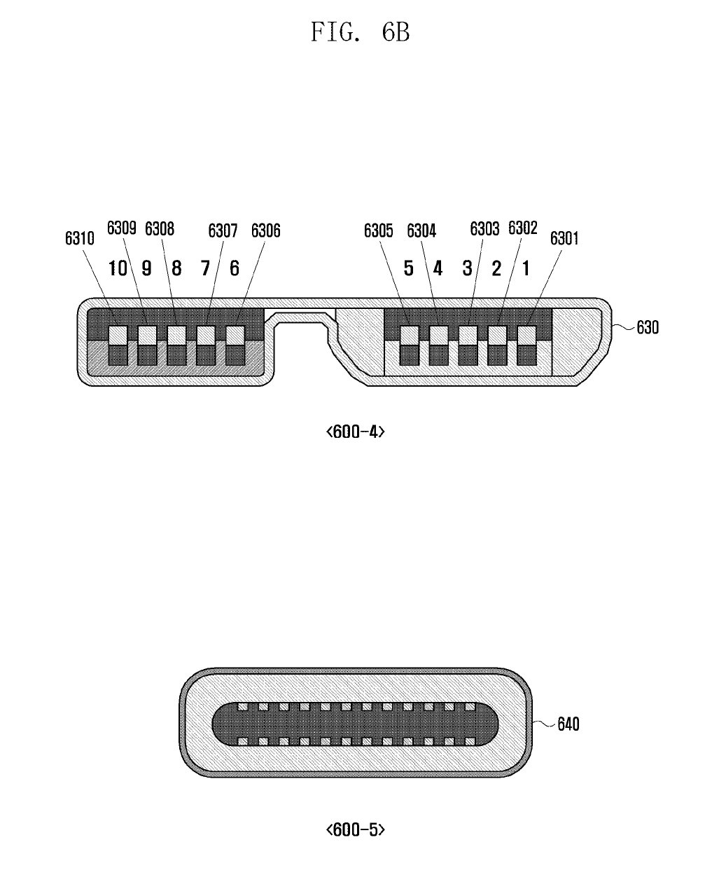

FIG. 6A is a cross-sectional view illustrating an example plug connector of USB 2.0 standard or USB 3.0 standard according to various example embodiments.

In various embodiments, the plug connector 200 of the USB OTG device 101 may include a type-A plug or type-B plug of the USB 2.0 standard. For example, referring to <600-1> of FIG. 6A, in at least parts of a type-A plug connector 600 or type-B plug connector (not shown), one end of a first pin 601 for delivering the power signal, one end of a second pin 602 for delivering the first differential data signal, one end of a third pin 603 for delivering the second differential data signal, and one end of a fourth pin 604 for delivering the ground signal may be arranged. In various example embodiments, the receptacle connector 100 of the USB OTG device 101 may include a type-A receptacle of the USB 2.0 standard corresponding to the type-A plug connector of the USB 2.0 standard or a type-B receptacle of the USB 2.0 standard corresponding to the type-B plug connector of the USB 2.0 standard.

In various example embodiments, the plug connector 200 of the USB OTG device 101 may include one of a Mini-A plug, a Mini-B plug, a Micro-A plug, and a Micro-B plug of the USB 2.0 standard. For example, referring to <600-2> of FIG. 6A, the USB plug connector 200 may include a Mini-A plug 610 of the USB standard 2.0 in which one end of a first pin 611 for delivering the power signal, one end of a second pin 612 for delivering the first differential data signal, one end of a third pin 613 for delivering the second differential data signal, one end of a fourth pin 614 for delivering the ground signal, and one end of a fifth pin 615 for delivering the device recognition signal may be arranged. The plug connector 200 may have any other arrangement order of pins, not limited to the above specific arrangement order of pins. The plug connector 200 may include a Mini-B plug, a Micro-A plug, or a Micro-B plug each of which is similar in shape to the Mini-A plug 610 of the USB 2.0 standard. In various example embodiments, the receptacle connector 100 of the USB OTG device 101 may include a Mini-A receptacle connector of the USB 2.0 standard connectable with the Mini-A plug connector of the USB 2.0 standard, a Mini-B receptacle connector of the USB 2.0 standard connectable with the Mini-B plug connector of the USB 2.0 standard, a Micro-A receptacle connector of the USB 2.0 standard connectable with the Micro-A plug connector of the USB 2.0 standard, or a Micro-B receptacle connector of the USB 2.0 standard connectable with the Micro-B plug connector of the USB 2.0 standard. In at least parts of the USB 2.0 standard receptacle connector 100 of the USB OTG device 101, the other end of the first pin 611 for delivering the power signal, the other end of the second pin 612 for delivering the first differential data signal, the other end of the third pin 613 for delivering the second differential data signal, the other end of the fourth pin 614 for delivering the ground signal, and the other end of the fifth pin 615 for delivering the device recognition signal may be arranged. The receptacle connector 100 of the USB OTG device 101 may include a Mini-AB receptacle connector of the USB 2.0 standard connectable with both the Mini-A plug connector of the USB 2.0 standard and the Mini-B plug connector of the USB 2.0 standard. Similarly, the receptacle connector 100 of the USB OTG device 101 may include a Micro-A/B receptacle connector of the USB 2.0 standard connectable with both the Micro-A plug connector of the USB 2.0 standard and the Micro-B plug connector of the USB 2.0 standard.

In various example embodiments, the plug connector 200 of the USB OTG device 101 may include a standard-A plug of the USB 3.0 standard or a standard-B plug of the USB 3.0 standard. For example, referring to <600-3> of FIG. 6A, the USB plug connector 200 may include a standard-A plug 620 of the USB 3.0 standard in which one end of a first pin 621 for delivering the power signal, one end of a second pin 622 for delivering the first differential data signal, one end of a third pin 623 for delivering the second differential data signal, one end of a fourth pin 624 for delivering a first ground signal, one end of a fifth pin 625 for delivering a first received signal (StdA_SSRX+), one end of a sixth pin 626 for delivering a second received signal (StdA_SSRX−), one end of a seventh pin 627 for delivering a second ground signal (GRD_drain), one end of an eighth pin 628 for delivering a first transmitting signal (StdA_SSTX+), and one end of a ninth pin 629 for delivering a second transmitting signal (StdA_SSTX−) may be arranged. The plug connector 620 may have any other arrangement order of pins, not limited to the above specific arrangement order of pins. The plug connector 200 may include a standard-B plug of the USB 3.0 standard which is similar in shape to the standard-A plug 620 of the USB 3.0 standard.

In various example embodiments, the receptacle connector 100 of the USB OTG device 101 may include a standard-A receptacle connector of the USB 3.0 standard connectable with the standard-A plug connector of the USB 3.0 standard or a standard-B receptacle connector of the USB 3.0 standard connectable with the standard-B plug connector of the USB 3.0 standard. In at least parts of the USB 3.0 standard receptacle connector of the USB OTG device 101, the other end of the first pin 621 for delivering the power signal, the other end of the second pin 622 for delivering the first differential data signal, the other end of the third pin 623 for delivering the second differential data signal, the other end of the fourth pin 624 for delivering the first ground signal, the other end of the fifth pin 625 for delivering the first received signal (StdA_SSRX+), the other end of the sixth pin 626 for delivering the second received signal (StdA_SSRX−), the other end of the seventh pin 627 for delivering the second ground signal (GRD_drain), the other end of the eighth pin 628 for delivering the first transmitting signal (StdA_SSTX+), and the other end of the ninth pin 629 for delivering the second transmitting signal (StdA_SSTX−) may be arranged.

FIG. 6B is a cross-sectional view illustrating an example plug connector of USB 3.0 standard or USB 3.1 standard according to various example embodiments.

In various example embodiments, the plug connector 200 of the USB OTG device 101 may include a Micro-B plug of the USB 3.0. For example, referring to <600-4> of FIG. 6B, the USB plug connector 200 may include a Micro-B plug 630 of the USB 3.0 standard. In at least parts of the Micro-B plug 630 of the USB 3.0 standard, one end of a first pin 6301 for delivering the power signal, one end of a second pin 6302 for delivering the first differential data signal, one end of a third pin 6303 for delivering the second differential data signal, one end of a fourth pin 6304 for delivering the device recognition signal, one end of a fifth pin 6305 for delivering the first ground signal, one end of a sixth pin 6306 for delivering the first transmitting signal (StdA_SSTX+), one end of a seventh pin 6307 for delivering the second transmitting signal (StdA_SSTX−), one end of an eighth pin 6308 for delivering the second ground signal (GRD_drain), one end of a ninth pin 6309 for delivering the first received signal (StdA_SSRX+), and one end of a tenth pin 6310 for delivering the second received signal (StdA_SSRX−) may be arranged. The plug connector 630 may have any other arrangement order of pins, not limited to the above specific arrangement order of pins.

In various example embodiments, the receptacle connector 100 of the USB OTG device 101 may include a Micro-B receptacle connector of the USB 3.0 standard connectable with the Micro-B plug connector of the USB 3.0 standard. In at least parts of the USB 3.0 standard receptacle connector of the USB OTG device 101, the other end of the first pin 6301 for delivering the power signal, the other end of the second pin 6302 for delivering the first differential data signal, the other end of the third pin 6303 for delivering the second differential data signal, the other end of the fourth pin 6304 for delivering the device recognition signal, the other end of the fifth pin 6305 for delivering the first ground signal, the other end of the sixth pin 6306 for delivering the first transmitting signal (StdA_SSTX+), the other end of the seventh pin 6307 for delivering the second transmitting signal (StdA_SSTX−), the other end of the eighth pin 6308 for delivering the second ground signal (GRD_drain), the other end of the ninth pin 6309 for delivering the first received signal (StdA_SSRX+), and the other end of the tenth pin 6310 for delivering the second received signal (StdA_SSRX−) may be arranged. The receptacle connector of the USB 3.0 standard may have any other arrangement order of pins, not limited to the above specific arrangement order of pins.

In various example embodiments, the plug connector 200 of the USB OTG device 101 may include a type-C plug of the USB 3.1 standard. For example, referring to <600-5> of FIG. 6B, the USB plug connector 200 may include a type-C plug 640 of the USB 3.1 standard. In at least parts of the type-C plug 640 of the USB 3.1 standard, one ends of twenty-four pins may be arranged. The functions of these pins are disclosed in United States Patent Application Publication No. 2105-0331826.

In various example embodiments, the receptacle connector 100 of the USB OTG device 101 may include a type-C receptacle connector of the USB 3.1 standard connectable with the type-C plug connector of the USB 3.1 standard. The other ends of the twenty-four pins may be arranged in at least parts of the type-C receptacle connector of the USB 3.1 standard of the USB OTG device 101.

While the present disclosure has been particularly shown and described with reference to an example embodiment thereof, it will be understood by those skilled in the art that various changes in form and details may be made therein without departing from the spirit and scope of the disclosure as defined by the appended claims.

What is claimed is:

1. A universal serial bus (USB) on-the-go (OTG) device comprising:
at least four pins configured to transmit or receive an electric signal;
a plug connector configured to be electrically connected with a USB receptacle connector of a first electronic device through first ends of the at least four pins; and
a receptacle connector configured to be electrically connected with a USB plug connector of a second electronic device through second ends of the at least four pins,
wherein at least portions of the first ends of the at least four pins are mounted in the plug connector, and at least portions the second ends of the at least four pins are mounted in the receptacle connector.

2. The USB OTG device of claim 1, wherein the at least four pins include:
a first pin for delivering a power signal;
a second pin for delivering a first differential data signal;
a third pin for delivering a second differential data signal; and
a fourth pin for delivering a ground signal.

3. The USB OTG device of claim 2, wherein the at least four pins further include:
a fifth pin for delivering a device recognition signal.

4. The USB OTG device of claim 1, wherein the plug connector includes one of a type-A plug and a type-B plug each of which is compatible for a USB 2.0 standard.

5. The USB OTG device of claim 1, wherein the plug connector includes one of a Mini-A plug, a Mini-B plug, a Micro-A plug, and a Micro-B plug each of which is compatible for a USB 2.0 standard.

6. The USB OTG device of claim 1, wherein the plug connector includes one of a standard-A plug and a standard-B plug each of which is compatible for a USB 3.0 standard.

7. The USB OTG device of claim 1, wherein the plug connector includes a Micro-B plug which is compatible for a USB 3.0 standard.

8. The USB OTG device of claim 1, wherein the plug connector includes a type-C plug which is compatible for a USB 3.1 standard.

9. The USB OTG device of claim 1, wherein the receptacle connector includes one of a type-A receptacle and a type-B receptacle each of which is compatible for a USB 2.0 standard.

10. The USB OTG device of claim 1, wherein the receptacle connector includes one of a Mini-A receptacle, a Mini-B receptacle, a Micro-A receptacle, and a Micro-B receptacle each of which is compatible for a USB 2.0 standard.

11. The USB OTG device of claim 1, wherein the receptacle connector includes one of a standard-A receptacle and a standard-B receptacle each of which is compatible for a USB 3.0 standard.

12. The USB OTG device of claim 1, wherein the receptacle connector includes a Micro-B receptacle which is compatible for a USB 3.0 standard.

13. The USB OTG device of claim 1, wherein the receptacle connector includes a type-C receptacle which is compatible for a USB 3.1 standard.

14. The USB OTG device of claim 1, further comprising:
a shieldcan encompassing at least portions of the plug connector and at least portions of the receptacle connector.

15. The USB OTG device of claim 14, further comprising:
a case disposed to protect an exterior of the shieldcan, the plug connector, and the receptacle connector.

16. The USB OTG device of claim 15, wherein the case has one shape selected from a tetrahedron, a pentahedron, a hexahedron, a heptahedron, and an octahedron.
